(19) United States
(12) Patent Application Publication
(10) Pub. No.: US 2016/0307258 A1
(43) Pub. Date: Oct. 20, 2016

(54) VIRTUAL ASSISTANT SERVER PROVIDING SERVICES REQUESTED THROUGH DEVICE COMMUNICATIONS

(71) Applicant: EBAY INC., San Jose, CA (US)

(72) Inventor: Ryan Christopher May, Elizabeth Bay (AU)

(21) Appl. No.: 14/690,135

(22) Filed: Apr. 17, 2015

(51) Int. Cl. G06Q 30/06

(52) U.S. Cl. CPC G06Q 30/0635

(57) ABSTRACT

There is provided systems and method for a virtual assistant server providing services requested through device communications. A service provider may provide a virtual assistant that may receive a message from a user's communication device having a text identifier that identifies a merchant and an item to order from the merchant. The user may input the text identifier through voice input using a voice to text module of the communication device. The message may include further information, such as a location of the user and communication device when communicating the message and a timestamp of the message, which may further be used to identify the merchant and/or item. The service provider may then determine a request for the item by the user and may utilize an ordering application provided by the service provider or a third party to submit an order to the merchant corresponding to the request.

### TECHNICAL FIELD

Example embodiments of the present application relate generally to service provider services processing electronic interactions between devices in a computer network, and more specifically to a virtual assistant server providing ordering services requested through device communications.

### BACKGROUND

Communication devices may allow for users to order items from merchants while the user is travelling through websites and/or dedicated applications of the merchants. For example, a restaurant may allow for a user to communicate an order to the restaurant for the user so that the order is ready on arrival of the user. The websites/applications may also allow for the user to enter payment information for the order to provide payment prior to arrival and further expedite the user's shopping experience. However, often these websites and/or applications are specific to a merchant or group of merchants, requiring new user accounts, device applications, and/or input for each merchant or each order with the merchant. Moreover, users are required to repetitively navigate an interface to place common orders, add items to a shopping cart, and/or enter payment information. Thus, the user may be required to provide sensitive information to multiple parties. Where one service provider may service multiple merchants through a single service provided by a website or application for the service provider, the website and/or application may require multiple inputs by the user to navigate order selection and payment, especially when the user differs from common orders, for example, when the user tries a new merchant or travels to a different area. Thus, ordering through the service provider may be time consuming and complicated.

### BRIEF DESCRIPTION OF THE DRAWINGS

FIG. 1 is a block diagram of a networked system suitable for implementing the process described herein, according to an embodiment;

FIG. 2 is an exemplary environment where a virtual assistant server may determine orders for users based user and device parameters for the users throughout the environment, according to an embodiment;

FIG. 3A is an exemplary payment provider server determining item purchase requests for a user based on received messages and other user and device parameters, according to an embodiment;

FIGS. 3B-3I are exemplary screenshots of a communication device interface and a payment provider's website interface when setting up a virtual assistant for item orders and submitting a message to the payment provider for the item order, according to an embodiment;

FIG. 4 is a flowchart of an exemplary process for a virtual assistant server providing services requested through device communications, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for a virtual assistant server providing ordering services requested through device communications. Systems suitable for practicing methods of the present disclosure are also provided.

In various embodiments, a payment provider may provide a virtual assistant to assist a user in submitting an order to a merchant through an ordering module provided by the payment provider or a third party service provider. A user may utilize a communication device to transmit a message to the payment provider that requests the payment provider to order a product, good, service, etc. (herein referred to as an “item” or “items”) from a merchant. The user may do so by utilizing a text or instant messaging protocol (e.g., SMS or MMS message, email, or instant messaging service, such as WHATSAPP®) to communicate the message to the payment provider. The user may generate the message on the communication device by typing the message into a message body using an input device/interface of the communication device and addressing the message to the payment provider using a messaging module (e.g., an application and associated hardware) or through a voice-to-text service of the messaging module (e.g., the application with a microphone and associated voice-to-text processes). In other embodiments, the virtual assistant process may be provided by another online entity, such as an online aggregator that may act as a facilitator for online orders. Thus, a task automator or other type of order logic system may provide the processes disclosed herein with respect to the virtual assistant.

The message may include text for processing by the payment provider, which may include a text identifier that the user has associated with both a specific item and a specific merchant offering the item. The text identifier may correspond to an alphanumeric and/or symbolic string of characters entered by the user, which may include words as well as associated numbers. Thus, the text identifier may correspond to a request by the user to order that specific item from that specific merchant. In this regard, the user may previously establish one or more text identifiers with the payment provider that identify a merchant (or merchants) and one or more items to order from such merchant(s) when the text identifier is communicated to the payment provider. In other embodiments, different information than a text identifier may be communicated to the payment provider in a message or with the text identifier in the message, such as a dollar amount for a bill that may be identified through a text identifier or a billing company/entity that may be identified through the text identifier. In other embodiments, a universal product code (UPC) may be used to identify a specific merchant and item, captured through a camera of the communication device.

The user may set other parameters for use with the text identifier so that the payment provider may determine the item and/or merchant when the text identifier is received. For example, the user may set coffee to mean an order for a regular cup of black coffee in the morning (e.g., around 9:00 AM) but a cup a decaffeinated coffee in the evening (e.g., past 5:00 PM). Other parameters besides time of day (e.g., a timestamp of transmitting and/or receiving the message) may include location of the user/communication device when sending the message, weather condition (e.g., temperature, rainy, cloudy, sunny, atmospheric pressure, etc.), traffic condition at or around the user, a type or identification of the device sending the messaging (e.g., mobile phone, home computer, tablet, work computer, etc.), and/or biometric of the user (e.g., heart rate, perspiration, identification of the user through a fingerprint/retinal scan, etc.). Thus, the payment provider may further determine either or both of the item and merchant using other received or detected parameters of the user, communication device, and/or environment when the message having the text identifier is received. As previously discussed, the payment may be to a merchant or other billing entity identified through the text identifier or other information, such as UPC code, and may include a dollar amount to the merchant where an item having an item price is not identified by the payment provider (e.g., a bill).

In other embodiments, the payment provider may intelligently select the merchant and/or the item based on user statistics and past information, as well as nearby merchants and/or orders by other users with nearby merchants. For example, if the user often orders from a certain coffee chain, that coffee chain may be selected as a nearby merchant if available (e.g., within walking distance or a certain amount of time until a next appointment for the user, start of work, exercise, etc.). Similarly, the merchant and/or item may be selected based on a highest rated nearby merchant (e.g., coffee shop with the highest YELP® rating and/or the most reviewed coffee item order at a coffee shop). Moreover, the payment provider may scrape and/or access online resources for the user to determine a merchant and/or item from user information and/or online actions, for example, social networking, microblogging, and/or media sharing services that the user may utilize to note preferences, interests, and/or likes. Thus, the payment provider may determine the merchant using available online information.

The user may then request the message be sent to the payment provider over a communication channel with the payment provider, such as a network connection of the communication device to a network (e.g., the Internet). The payment provider may utilize a virtual assistant module to receive the message and determine the merchant and item using the text identifier in the message (as well as other parameters set by the user, available resources, and/or user information). The payment provider may determine that the user is requesting to order the item from the merchant based on receiving the message. The payment provider may then utilize an ordering service to generate an order to communicate to the merchant to order the item from the merchant for the user. The ordering service may be provided by the payment provider or may be provided by a third party service provider, such as an ordering website/application of a service provider utilizing payment services of the payment provider. The payment provider may further process and complete a payment to the merchant on behalf of the user for the item using a payment instrument for the user, which may include a payment card (e.g., a debit/credit card), a bank account, a payment account with the payment provider, or other type of financial instrument. In various embodiments, the text identifier may also denote the payment instrument or other user parameters may be used for selection of the payment instrument. For example, the user may state “Coffee on work credit card” to purchase a coffee order using a credit card used for work.

In various embodiments, the message may include words, characters, or other information not recognized by the payment provider. In such embodiments, the virtual assistant module of the payment provider may request clarification from the user of the unknown information. The user may then access the payment provider or may provide a follow up message to resolve the unclear terms. For example, the user may set the unknown terms to be associated with a new or different item, specification of the item (e.g., ingredient), and/or merchant. However, if the user has mistakenly entered the unknown information, the user may request the unknown information be ignored, and the payment provider may continue with processing the message as described above. Moreover, the user may also be provided with usable commands available with the virtual assistant on request or in the event on unrecognizable commands. For example, if the user enters “Available Commands” to a message, the virtual assistant may provide such available commands. Moreover, if the user enters unrecognizable text or other information, then the virtual assistant may respond with all available commands or available commands most closely related to the received text.

The user may also set preorders with the message and/or have the virtual assistant module set future and/or reoccurring orders. For example, the message may include information in one or more text identifiers that may correspond to a time to either submit the order to the merchant or request the merchant have the item ready by. The time may be a future time, or an amount of time from the current time. Such preorder information may be set with a text identifier, or may be entered to the message (e.g., 30 minutes to signify the wait time). The preorder time may also be determined from user and/or environmental conditions, such as an amount of time it may take the user to arrive at the merchant. Thus, where the merchant and/or third party ordering service do not provide preordering, the virtual assistant module may provide preordering by waiting the appropriate amount of time to order the item from the merchant.

The virtual assistant module may further determine recurring orders by the user, for example, from messages sent by the user, settings of the user, and/or purchase histories of the user. The virtual assistant may set up a recurring order for the item from the merchant based on the recurring orders. Thus, the order may be submitted to the merchant without requiring a message from the user. Moreover, the virtual assistant module may monitor user activity (e.g., location, biometrics, messages, etc.) and/or environmental activity (e.g., weather, traffic, etc.) to determine whether the user is varying from a normal pattern of behavior where the user would normally order and pick up the item from the merchant in the recurring order. Thus, if the user is out of town, taking the day off, going to be to work late, or otherwise unable (or does not desire to) order and pick up the item, the virtual assistant module may not order the item from the merchant. The virtual assistant module may also request the user to confirm the order prior to purchasing through their communication device if user/environment information differs from a regular course of action.

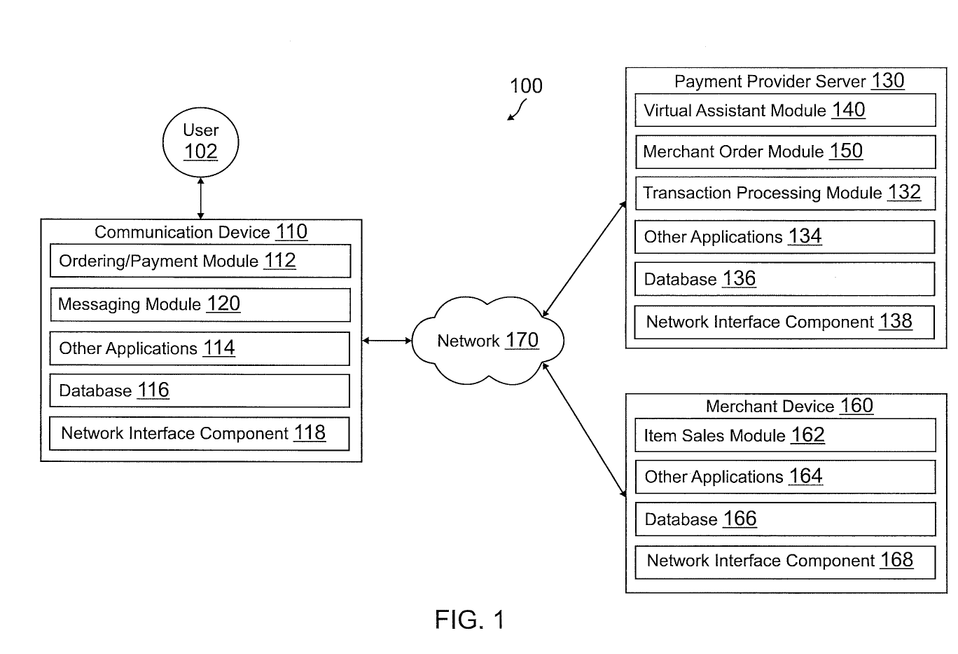

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a communication device 110, a payment provider server 130, and a merchant device 160 in communication over a network 170. User 102, such as a consumer, may utilize communication device 110 to enter a message, for example, using a messaging application that may receive input throughout an input device, such as a microphone (e.g., using voice to text processes) touch interface, keyboard, mouse, or other input device. The message may include a text identifier that identifies both a merchant and an item to order from the merchant. The message may be communicated to payment provider server 130 for processing, which may determine what item the user is requesting and the merchant to order the item from. Payment provider server 130 may then have an order for the item submitted to merchant device 160 associated with the merchant.

Communication device 110, payment provider server 130, and merchant device 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

Communication device 110 may be implemented using any appropriate hardware and software configured for wired and/or wireless communication with payment provider server 130 and/or merchant device 160. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a merchant device is shown, the merchant device may be managed or controlled by any suitable processing device (e.g., a server and/or cloud computing system). Although only one merchant device is shown, a plurality of merchant devices may be utilized.

Communication device 110 of FIG. 1 contains a ordering/payment module 112, a messaging module 120, other applications 114, a database 116, and a network component interface 118. Ordering/payment module 112, messaging module 120, and other applications 114 may correspond to executable processes, procedures, and/or applications with associated hardware. In other embodiments, communication device 110 may include additional or different software as required.

Ordering/payment module 112 may correspond to one or more processes to execute modules and associated specialized hardware of communication device 110 to provide a convenient interface to permit user 102 to enter an order to ordering/payment module 112 and submit the order to a service provider, which may forward the order to a merchant corresponding to merchant device 160 for fulfillment. In various embodiments, ordering/payment module 112 may instead correspond to the merchant itself, so that ordering/payment module 112 may communicate the order to merchant device 160 directly. Ordering/payment module 112 may correspond to specialized hardware and/or software configured to transmit and receive information, such as communicate orders with the merchant corresponding to merchant device 160 and payment information for the order and receive order confirmation and details associated with fulfillment of the order. Thus, when communication device 110 is connected to network 170, ordering/payment module 112 may communicate information over network 170. In various embodiments, ordering/payment module 112 may correspond to a general web browser of communication device 110 used to access a website of an ordering service and/or merchant and submit orders to the merchant, for example, available over the Internet. However, in other embodiments, ordering/payment module 112 may correspond to a dedicated application of the service provider and/or merchant, which may be utilized with a specific service provider and/or merchant to submit orders to the merchant for fulfillment.

Thus, ordering/payment module 112 may receive input from user 102 through an input device of communication device 110 for an order for user 102. The order may then be communicated to the proper entity for processing. In order to communicate orders, ordering/payment module 112 may also require payment information, which may be input to ordering/payment module 112 and stored for future use. Ordering/payment module 112 may also provide user accounts for use in ordering with a merchant. In certain embodiments, ordering/payment module 112 may utilize payment provider server 130, such as PAYPAL® of San Jose, Calif., to provide payment and/or establish a user account for orders. In such embodiments, ordering/payment module 112 may also be configured to enable user 102 to enter order options, select payment instruments, and/or submit orders, as discussed herein. Ordering/payment module 112 may further store past transactions and orders, as well as common orders for user 102 based on past orders. Thus, ordering/payment module 112 may allow for communication device 110 and/or payment provider server 130 to retrieve such order histories for use in associating text identifiers with such orders, as discussed herein. However, in other embodiments, a device or server accessible over network 170 may store such information.

Ordering/payment module 112 may require multiple inputs and menu navigation to submit an order for an item from a merchant. Thus, messaging module 120 may be utilized to communicate an order to payment provider server 130 through a message entered to messaging module 120, which may process the message to determine the requested item and merchant, as discussed herein. Thus, messaging module 120 may correspond to one or more processes to execute modules and associated specialized hardware of communication device 110 to send and/or receive one or more messages to payment provider server 130, for example, by receiving input for a message from user 102, communicating the message to payment provider server 130, receiving reply messages from payment provider server 130 (e.g., a message acknowledging receipt of the original message from user 102 and/or acceptance/fulfillment of the order by the merchant associated with merchant device 130), and output the reply messages to user 102, such as through audio output, visual output, and/or audiovisual output. In this regard, messaging module 120 may correspond to specialized hardware and/or software utilized to provide a convenient interface to receive input from user 102 through an input device of communication device 110, such as a keyboard, mouse, touchscreen interface, microphone, or other input device. Thus, user 102 may provide text input to messaging module 120 using a voice to text process of messaging module 120, in certain embodiments. Messaging module 120 may enter the input to a message associated with SMS, MMS, email, instant messaging, or other type of message protocol. Once user 102 is satisfied with the message, user 102 may utilize messaging module 120 to communicate the message to payment provider server 130 for processing and determination of a request by user 102 for an item from a merchant, as discussed herein.

Messaging module 120 may also receive messages from payment provider server 130 and/or merchant device 160 and output the messages to user 102 using an output module of communication device 110. Messaging module 120 may receive a message from communication module 118 communicated by payment provider server 130 and/or merchant device 160. The message may be interactive, allowing for contact of the merchant, lookup of a merchant address, and/or entry of the merchant location and/or contact information to another application of communication device 110 (e.g., a mapping, phone call, etc., application). For example, messaging module 120 may be implemented as a user interface where user 102 may view the information in the message and then make selections. The messages may be communicated over network 170 to communication device 110. Messaging module 120 may also receive messages from nearby communication and/or merchant devices using short range wireless communications, for example, one of near field communication, radio communication, infrared communication, Bluetooth communication, Bluetooth Low Energy (BLE) communication, LTE Direct communication, and WiFi communication. The messages may include messages acknowledging receipt of a message sent by user 102 using communication device 110 to payment provider server 130 (e.g., acknowledgment of a request for an item from a merchant), requests for clarifications of unknown input in a message sent by user 102, information about submission of a corresponding order for a message to merchant device 130, and/or information about pickup of the item from the merchant associated with merchant device 160 (e.g., a pickup time, transaction cost, merchant location, etc.).

In various embodiments, one or more features of ordering/payment module 112 and messaging module 120 may be incorporated the same module so as to provide their respective features in one interface, process, or multiple processes.

Communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 170, or other types of applications. In various embodiments, other applications 114 may include financial applications, such as banking, online payments, money transfer, or other applications associated with payment provider server 130. Additionally, other applications 114 may include social networking/media, microblogging, and/or mapping applications, which may be used with messaging module 120 and/or payment provider server 130 to determine a request and/or reorders/preorders for an item from a merchant based on information available from such application. Other applications 114 may contain other software programs, executable by a processor, including a graphical user interface (GUI) configured to provide an interface to the user.

Communication device 110 may further include database 116 which may include, for example, identifiers such as operating system registry entries, cookies associated with ordering/payment module 112, messaging module 120, and/or other applications 114, identifiers associated with hardware of communication device 110, or other appropriate identifiers, such as identifiers used for payment/user/device authentication or identification. In one embodiment, identifiers in database 116 may be used by payment provider server 130 to associate communication device 110 with a particular account maintained by payment provider server 130. Database 116 may further store past orders and transactions histories for ordering/payment module 112. Additionally, messages sent and/or received using messaging module 120 may be stored to database 116.

In various embodiments, communication device 110 includes at least one network interface component 118 adapted to communicate with payment provider server 130 and/or merchant device 160. In various embodiments, network interface component 116 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Payment provider server 130 may be maintained, for example, by an online payment service provider, which may provide payment services for users (e.g., consumers) and/or merchants, as well as a virtual assistant that may provide for determination of item requests from a merchant based on a received message having a text identifier. In this regard, payment provider server 130 includes one or more processing applications, which may provide the aforementioned services, for example, by communicating orders sent in a message by communication device 110 to merchant device 160. In one example, payment provider server 130 may be provided by PAYPAL®, Inc. of San Jose, Calif., USA. However, in other embodiments, payment provider server 130 may be maintained by or include a merchant, financial services provider, and/or other service provider, which may provide virtual assistant and payment services to user 102. Payment provider server 130 may additionally provide use of user and payment accounts for ordering and payment of items. Although payment provider server 130 is described as separate from merchant device 160, it is understood that a merchant device/server and/or a separate service provider (e.g., providing ordering services to user 102) may include one or more features provided by payment provider server 130.

Payment provider server 130 of FIG. 1 includes a virtual assistant module 140, a merchant order module 150, a transaction processing module 132, other applications 134, a database 136, and a network interface component 138. Virtual assistant module 140, merchant order module 150, transaction processing module 132, and other applications 134 may correspond to executable processes, procedures, and/or applications with associated hardware. In other embodiments, payment provider server 130 may include additional or different software as required.

Virtual assistant module 140 may correspond to one or more processes to execute modules and associated specialized hardware of payment provider server 130 to provide a virtual assistant that may access/receive a message communicated by communication device 110 to payment provider server 130, determine a request for an item from a merchant based on one or more text identifiers in the message (as well as order instructions, payment instruments, and other information based on the message and user parameters), and cause an order for the item from the merchant to be generated and communicated to merchant device 160. In this regard, virtual assistant module 140 may correspond to specialized hardware and/or software of payment provider server 130 to receive and/or access a received message from communication device 110. As discussed herein, messaging module 120 may be used by user 102 to enter input for a message and communicate the message to payment provider server 130. The message may include one or more text identifiers that may correspond to an item and/or merchant to order the item from (as well as a payment instrument used to pay the merchant for the item and any ordering instructions, such as a preorder time, in various embodiments). Virtual assistant module 140 may then determine the text identifier(s) in the message based on previously received information in order to determine what item user 102 is requesting and from which merchant user 102 is requesting the item to be ordered from.

Thus, user 102 may establish the text identifiers to be associated with the item and/or merchant using virtual assistant module 140 through accessing virtual assistant module 140 over network 170 using communication device 110 and/or another device. User 102 may set a text identifier as an alphanumeric and/or symbolic string of characters entered by user 102 to the body of a message, which may include words as well as associated numbers. Further, user 102 may set the text identifier to correspond to a request by user 102 to order an item from a merchant. In order to do so, user 102 may identify a merchant (or merchants) and one or more items to order from such merchant (or merchants) when the text identifier is communicated to virtual assistant module 140. For example, user 102 may set a text identifier as “coffee” that orders a regular sized cup of black coffee from a selected coffee merchant whenever virtual assistant module 140 receives a message from communication device 110 including the text identifier “coffee.”

In various embodiments, user 102 may set other parameters for use with the text identifier so that virtual assistant module 140 may determine the item and/or merchant when the text identifier is received based on detection and/or reception of information indicating the other parameters. For example, user 102 may instead set “coffee” to mean a cup of black coffee from a merchant closest to user 102 (e.g., determined from detecting and/or receiving location information for user 102). In other embodiments, another parameter may be associated with “coffee” such that a message having “coffee” orders a regular cup of black coffee in the morning (e.g., around 9:00 AM) but a cup a decaffeinated coffee in the evening (e.g., past 5:00 PM). Virtual assistant module 140 may receive information about the parameter from communication device 110, merchant device 160, and/or a third party resource, including location detection resources, social networking services, messaging platforms, weather and traffic tracking services, and/or other available resource. Thus, parameters that may be associated with a text message may include a timestamp of transmitting and/or receiving the message, location of user 102/communication device 110 when sending the message, weather condition (e.g., temperature, rainy, cloudy, sunny, atmospheric pressure, etc.), traffic condition at or around user 102, a type or identification of communication device 110 sending the messaging (e.g., mobile phone, home computer, tablet, work computer, etc.), and/or biometric of user 102 (e.g., heart rate, perspiration, identification of the user through a fingerprint/retinal scan, etc.). In other embodiments, further parameters may also be used, including financial information for user 102 (e.g., a balance of a bank account, rewards information with one or more merchants, credit rating for user 102, extended credit to user 102, etc.). Thus, virtual assistant module 140 may further determine either or both of the item and merchant using other received or detected parameters of user 102, communication device 110, and/or environmental factors and information when the message having the text identifier is received.

In further embodiments, virtual assistant module 140 may intelligently select the merchant and/or the item based on user 102's statistics and past information, as well as nearby merchants and/or orders by other users with nearby merchants. Virtual assistant module 140 may request, scrape, and/or access online information for user 102, other users, and/or merchant, including users and/or merchants nearby a location for user 102. Online resources may include messages and social networking interactions of other users, online review sites for merchants, user 102's social networking, microblogging, and/or media sharing service interactions, user 102's purchase histories and transactions, online merchant websites and/or ordering and item availability resources, or other types of online websites and resources (e.g., accessible server databases). Thus, in various embodiments, if user 102 often orders from a certain coffee chain, that coffee chain may be selected as a nearby merchant if available (e.g., within walking distance or a certain amount of time until a next appointment for user 102, start of work, exercise, etc.). Such information may be determined from a user “like” on a social networking site, from user check-ins, and/or from transaction histories of user 102. Similarly, the merchant and/or item may be selected based on a highest rated nearby merchant (e.g., coffee shop with the highest YELP® rating and/or the most reviewed coffee item order at a coffee shop).

Once virtual assistant module 140 determines what item user 102 would like to purchase and which merchant user 102 is requesting to purchase the item from, virtual assistant module 140 may determine a purchase request for the item from the merchant based on the message communicated to virtual assistant module 140 by communication device 110. Virtual assistant module 140 may then utilize merchant order module 150 to generate an order communicated to merchant device 160 or may utilize a third party ordering service, as discussed herein. In various embodiments, virtual assistant module 140 may determine a payment instrument to utilize to provide payment to the merchant associated with merchant device 160 for purchase of the item. User 102 may set a payment instrument to always be used to provide payment, such as a payment card (e.g., debit/credit/gift card), banking account, and/or payment account with payment provider server 130. User 102 may also set payment instruments for specific text identifiers, items, and/or merchants, or may provide one or more text identifiers to be associated with the payment instruments such that receipt of the text identifier with any other text identifiers for an item/merchant will utilize that payment instrument. In other embodiments, virtual assistant module 140 may select the payment instrument based on other factors, such as rewards information and/or benefits for user 102 with a merchant or merchants, credit rating effects and/or offers for user 102, security issues for user 102 based on location and/or merchant, or other factors. Moreover, in other embodiments, user 102 and/or virtual assistant module 140 may instead have user 102 provide payment to the merchant associated with merchant device 160 when user 102 arrives at the merchant location and picks up the item that user 102 has ordered using the message.

Virtual assistant module 140 may allow for preordering of one or more items so that virtual assistant module will only cause the order for the requested item from the merchant to be submitted to the merchant at a certain time or after a certain time period. For example, merchant order module 150 and/or the third party ordering service may not provide for preordering of an item. Thus, virtual assistant module 140 may allow user 102 to preorder an item so that the item is prepared and/or ready at a certain pickup time (e.g., 9:00 AM) or after a certain time period (e.g., in 30 minutes from the present time). User 102 may set the preorder time/amount of time with a text identifier, may enter the information into a message communicated to virtual assistant module 140 (e.g., include “in 30 minutes” or “at 9 AM” in the message), or may further set text identifiers to be associated with a time/amount of time. Such information may be communicated to virtual assistant module 140 by user 102 in the message including the text identifier that identifies the item and merchant.

Virtual assistant module 140 may also determine common orders for user 102 that user 102 reorders often or regularly and when user 102 wishes to reorder such items and from what merchants. Virtual assistant module 140 may establish a reorder for such item(s) on user 102's approval and may cause an order to be submitted for the item from the associated merchant without receiving a message from user 102 based on the time/circumstances that user 102 would normally request the order. Thus, virtual assistant module 140 may not require user 102 to submit a message for all orders. Virtual assistant module 140 may further track user 102's parameters to determine if user 102 is differing from a course of action where user 102 would normally order the item in the reorder. For example, user 102 may travel, be home sick from work, not exercising that day, or otherwise deviate from the schedule so that user 102 would not order the item in the reorder set with virtual assistant module 140. Virtual assistant module 140 may pause reordering where a parameter of user 102 (e.g., location, biometric, message, social networking interaction, etc.) differs from normal parameters for ordering the item. Virtual assistant module 140 may request user 102 to confirm or decline the reorder through communication device 110, and may only cause the order to be generated and communicated to merchant device 160 where user 102 confirms that user 102 would like to order the item from the merchant. In other embodiments, merchant order module 150 and/or the third party ordering service may provide for preordering and/or reordering for common orders so that user 102 may set such preferences using merchant order module 150 and/or the third party ordering service.

In certain embodiments, virtual assistant module 140 may provide further services based on a received message. For example, a message including text of “history,” “interest,” “lesson,” or other text may correspond to a general process for virtual assistant module 140 to provide information to user 102, which may be information stored to database 136 and/or available over network 170, such as historical information for the day, time, location, etc. Virtual assistant module 140 may also perform a check-in for user 102 that identifies user 102 with a location by checking user 102 into the location so that entities may be alerted that user 102 is located at the location. User 102 may communicate a message with “check-in” or other text to initiate the check-in process. Thus, payment provider server 130, merchant device 160, and/or another device/server (e.g., associated with a social networking service) may then identify user 102 with the location, which may be viewable by other users and entities, for example, to advertise to user 102, communicate with user 102, and/or find user 102 at the location.

After determination of the request for the item from the merchant by virtual assistant module 140, virtual assistant module 140 may request that merchant order module 150 generate a purchase order for the item from the merchant for communication to merchant device 160. Merchant order module 150 may correspond to one or more processes to execute modules and associated specialized hardware of payment provider server 130 to receive the request to order the item from the merchant, generate an order for the item from the merchant, and cause to be communicated the order to merchant device 160 for fulfillment. In this regard, transaction processing module 132 may correspond to specialized hardware and/or software of payment provider server 130 to access the purchase requested determined by virtual assistant module 140 using a received message. Merchant order module 150 may then generate an order for the item in the purchase request from the merchant in the purchase request. The order may include further information, such as a payment instrument to communicate to merchant device 160 for processing. However, in other embodiments, transaction processing module 132 may provide for payment processing with merchant device 160. Merchant order module 150 may provide user identification with the order so that the merchant may properly provide the item to user 102. Once generated, the order may be communicated using network interface component 138 to merchant device 160. In other embodiments, a third party service provider may provide the item ordering as described above, for example, an external service provider device or server.

Merchant order module 150 may also provide for payments to other entities, which may complete orders to other merchants, for bills, or otherwise assist in completing a payment requested by user 102. For example, a message may be received that identifies an order to be placed with a service provider, which may process the order to request items from an associated merchant (e.g., a merchant using the service provider's online marketplace). In other embodiments, the message may correspond to a bill that user 102 would like to pay, such as a utilities bill, rent, car/house payment, credit card or other extended credit bill, or other types of payable bills. The message may identify the bill, allowing for identification of the amount to pay, or the message may include a payment amount (e.g., dollar amount) for payment to the identified entity. Once virtual assistant module 140 determines the requested payment by user 102 in the message, merchant order module 150 may process the request to generate a payment request using an identified payment instrument.

As previously discussed, merchant order module 150 may correspond to an ordering service by another entity, such as the service provider that orders items from associated merchant (e.g., using the service provider's marketplace). However, and as described above, merchant order module 150 may also correspond to an entity that processes the request to send a payment request to another billing entity or service provider, which may process the payment request to complete the payment requested by user 102 (e.g., payment for a bill, payment to a merchant). In various embodiments, merchant order module 150 may provide a payment instrument for processing. Such payment instrument may include a payment card or account, a financial account, or other type of payment medium. In various embodiments, user 102 may also specify a physical payment instrument to be provided to the entity in the payment request to the entity. For example, a check may be provided to a billing entity.

Transaction processing module 132 may correspond to one or more processes to execute modules and associated specialized hardware of payment provider server 130 to receive and/or transmit information from communication device 110 and/or merchant device 160 for processing and completion of financial transactions. In this regard, transaction processing module 132 may correspond to specialized hardware and/or software of payment provider server 130 to process financial transaction information. Transaction processing module 132 may receive a request to complete a sale transaction for an item with communication device 110 and merchant device 160. Transaction processing module 132 may complete the sale transaction by providing payment from user 102 from a merchant associated merchant device 160, for example, through a transfer of funds between payment accounts and/or providing a payment token to merchant device 160 for processing to receive funds for the transaction. Additionally, transaction processing module 132 may provide transaction histories, including receipts, for use by communication device 110 and/or merchant device 160 to complete a financial transaction.

In various embodiments, one or more features of virtual assistant module 140, merchant order module 150, and/or transaction processing module 132 may be incorporated the same module so as to provide their respective features in one interface, process, or multiple processes.

In various embodiments, payment provider server 130 includes other applications 134 as may be desired in particular embodiments to provide features to payment provider server 130. For example, other applications 134 may include security applications for implementing server-side security features, programmatic server applications for interfacing with appropriate application programming interfaces (APIs) over network 170, or other types of applications. Other applications 134 may contain software programs, executable by a processor, including a graphical user interface (GUI), configured to provide an interface to a user.

Additionally, payment provider server 130 includes database 136. As previously discussed, user 102 and a merchant corresponding to merchant device 160 may establish one or more payment accounts with payment provider server 130. Payment accounts in database 136 may include user/merchant information, such as name, address, birthdate, payment/funding information, additional user financial information, and/or other desired user data, including user identifiers/tokens for use in identifying the payment account. User 102 and the merchant may link payment accounts to communication device 110 and/or merchant device 160 through an identifier. Thus, when the identifier is transmitted to payment provider server 130, e.g., from communication device 110 and/or merchant server 120, an account belonging to user 102 and/or the merchant may be found. In other embodiments, user 102 and/or the merchant may not have previously established a payment account and other financial instrument or information may be provided. Moreover, database 136 may also store information used by virtual assistant module 140, merchant order module 150, and/or transaction processing module 132, for example, received messages, established text identifiers with associated information, determined purchase requests, generated purchase orders, and/or completed transactions and transaction histories.

In various embodiments, payment provider server 130 includes at least one network interface component 138 adapted to communicate with communication device 110 and/or merchant device 160 over network 170. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Merchant device 160 may be implemented using any appropriate hardware and software configured for wired and/or wireless communication with communication device 110 and/or payment provider server 130. For example, in one embodiment, merchant device 160 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a merchant device is shown, the merchant device may be managed or controlled by any suitable processing device. Although only one merchant device is shown, a plurality of merchant devices may function similarly. Although merchant device 160 is described in reference to a merchant, which may receive an order from virtual assistant module 140, in other embodiments, another type of server, device, or other online entity (e.g., collection of servers and/or devices, such as an online marketplace providing a service to multiple merchants) may correspond to merchant device 160. For example, a service provider such as AMAZON® or EBAY® may provide an online marketplace visited through a service provider website or dedicated application, and may allow for ordering from the service provider or merchant affiliated with the service provider (e.g., selling through the online marketplace). In such embodiments, the service provider may offer similar services as described below, and virtual assistant module 160 may provide the order to the service provider for fulfillment using the online marketplace.

Merchant device 160 of FIG. 1 contains an item sales module 162, other applications 164, a database 166, and a network interface component 168. Item sales module 162 and other applications 164 may correspond to executable processes, procedures, and/or applications with associated hardware. In other embodiments, merchant device 160 may include additional or different software as required.

Item sales module 162 may correspond to one or more processes to execute modules and associated devices of merchant device 160 to provide a convenient interface to permit a merchant for merchant device 160 to enter, view, and/or process items user 102 wishes to purchase and view incoming purchase orders from payment provider server 130 or a third party ordering service for fulfillment by the merchant. In this regard, item sales module 162 may correspond to specialized hardware and/or software utilized by merchant device 160 that may be implemented as an application having a user interface enabling the merchant to enter and/or view the items user 102 has selected for purchase (e.g., from a received purchase order). Item sales module 162 may further enable the merchant to enter coupons and/or discounts for the items, edit the order including adding, removing, and/or modifying items, or other functions with regards the selected items in the purchase order. Once the items have been arranged into an order for purchase by user 102, a total may be calculated and a transaction may be engaged with user 102 to complete payment for the selected items, for example, through a received payment instrument. Thus, item sales module 162 may request payment covering the selected items from user 102. However, in other embodiments, payment provider server 130 may perform the transaction cost calculation and processing of payment for the transaction. Item sales module 162 may alert the merchant when payment for the transaction for the item(s) is completed and may instruct the merchant and/or a merchant employee to prepare the item(s) for fulfillment of the purchase order. Item sales module 162 may also be used to communicate information to communication device 110 and/or payment provider server 130, such as messages to alert user 102 of order fulfillment and/or pickup instructions or to cancel an order where the order may not be fulfilled (e.g., lacking of the items for the order). In various embodiments, the processes provided by item sales module 162 may correspond to a device external to merchant device 160, such as a receipt printout device having a connection with payment provider server 130 that may alert the merchant of the order for fulfillment.

As discussed herein, in various embodiments, other types of merchants, billing entities, and/or service providers may instead correspond to merchant device 160, including entities generating bills for user 102 (e.g., rent, electricity, student loans, car/house payments, etc.) and/or online service providers that sell items or offer an online marketplace for use by other merchants to sell items. In such embodiments, item sales module 162 may receive other types of payments and/or orders, including bill payments or an order with another merchant. Item sales module 162 may facilitate payment for the bill or payment to the merchant using a received payment request for the bill/merchant generated from a message sent by user 102 to virtual assistant module 140. In this regard, instead of an order, item sales module 162 may receive a payment request including a payment instrument used to provide the payment. Moreover, item sales module 162 may also correspond to legacy system modules, including orders that may be received over the phone, through bank transfers, and through physical payment instruments, such as a mailed check, money order, or other type of physical payment means (including cash). Thus, the received payment instrument may include payment card, payment accounts, bank accounts, and/or physical payment instruments, which may be received with an amount to charge using the payment instrument as well as for what the payment request is to be used (e.g., pay a merchant, pay for a bill, etc.). Item sales module 162 may process the payment instrument for the amount and may complete payment for the matter associated with the payment request. In the event a physical payment instrument is provided by virtual assistant module 140, the physical payment instrument may be scanned, entered by an employee or administered, or otherwise processed (e.g., deposited with a bank in a bank account), to complete the payment.

Merchant device 160 includes other applications 164 as may be desired in particular embodiments to provide features to merchant device 160. For example, other applications 164 may include security applications for implementing client-side security features, programmatic client applications for interfacing with appropriate application programming interfaces (APIs) over network 170, or other types of applications. Other applications 164 may also include email, texting, voice and IM applications that allow a merchant to send and receive emails, calls, texts, and other notifications through network 170. In various embodiments, other applications 164 may include financial applications, such as banking, online payments, money transfer, or other applications associated with a payment provider server. Other applications 164 may contain software programs, executable by a processor, including a graphical user interface (GUI) configured to provide an interface to the user.

Merchant device 160 may further include database 166 which may include, for example, identifiers such as operating system registry entries, cookies associated with item sales module 162 and/or other applications 164, identifiers associated with hardware of merchant device 160, or other appropriate identifiers, such as identifiers used for payment/user/device authentication or identification. Identifiers in database 166 may be used by a payment/service provider to associate merchant device 160 with a particular account maintained by the payment/service provider. Database 166 may also further store received purchase orders for fulfillment.

Merchant device 160 includes at least one network interface component 168 adapted to communicate with communication device 110 and/or payment provider server 130 over network 170. In various embodiments, network interface component 168 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

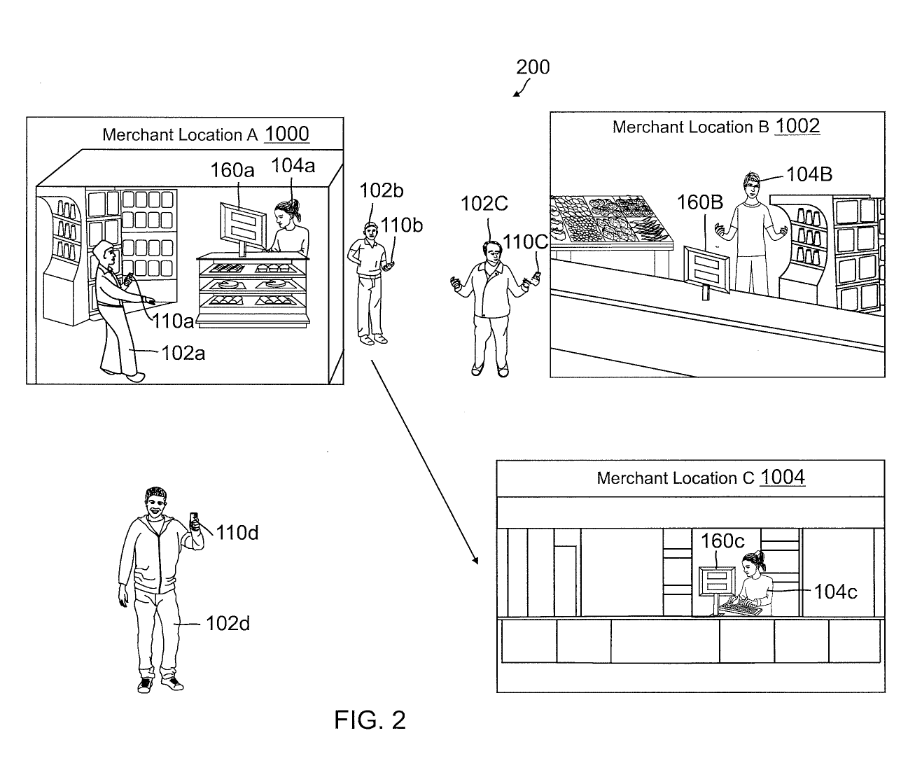

FIG. 2 is an exemplary environment where a virtual assistant server may determine orders for users based user and device parameters for the users throughout the environment, according to an embodiment. Environment 200 of FIG. 2 includes a user 102a having a communication device 110a, a user 102b having a communication device 110b, a user 102c having a communication device 110c, and a user 102d having a communication device 110d all corresponding generally to user 102 with communication device 110, respectively, in environment 100 of FIG. 1. Moreover, environment 200 includes a merchant device 160a, a merchant device 160b, and a merchant device 160c all corresponding generally to merchant device 160 in environment 100.

In environment 200, users 102a-d travel through an environment having a merchant location A 1000, a merchant location B 1002, and a merchant location C 1004, for example, a mall, town, city, or other type of environment where a plurality of merchants may be located. While traveling through environment 200, users 102a-d may wish to order items from the merchants located at merchant location A 1000, merchant location B 1002, and/or merchant location C 1004, such as a merchant 104a, a merchant 104b, and/or a merchant 104c, respectively, using a virtual assistant service provided by a service provider, such as payment provider server 130 of environment 100. For example, user 102a may utilize communication device 110a to send a message to the virtual assistant requesting that merchant 104a prepare an order of food available at merchant location A 1000 for pickup by user 102a when user 102a arrives at merchant location A 1000. Merchant 104a may view the order on merchant device 160a and prepare to order so that user 102a located within merchant location A 1000 may pick up the order and bypass a wait or line at merchant location A 1000.

Similarly, user 102b is shown as travelling to merchant location C 1004. Thus, prior to arriving at merchant location C 1004, user 102b may utilize communication device 110b to send a message to the virtual assistant having a text identifier allowing the virtual assistant to determine what item user 102b is requesting and that user 102b is requesting the item from merchant 104c at merchant location C 1004. Since user 102b is located nearby merchant location A 1000 and may have to travel a considerable distance to merchant location C 1004, user 102b may set a preorder time or amount of time, so that merchant 104c knows when to prepare the order by for pickup by user 102b. Thus, the order may not be prepared too far in advance where the order may become unwanted by user 102b, for example, if it is stale, cold, melted, etc., in the case of a food item. The virtual assistant may determine the item, merchant 104c to request the item from, and/or the preorder time based on the message contents, such as the text identifier(s) and/or a parameter for user 102b. Thus, if user 102b is located 2 miles away from merchant location C 1004, an amount of time for user 102b to get to merchant location C 1004 may be factored into the determination of the preorder time, which may include a mode of transportation of user 102b and/or a travel route for user 102b (e.g., walking and a foot path, driving and the streets/lights user 102b may be required to take, etc.).

User 102c may wish to order an item, however, not have a preference for a merchant to order the item from, may not know nearby merchants that sell the item, or may not have set a merchant to order the item from with a text identifier for the item. Thus, when user 102c utilizing communication device 110c to order the item by submitting the text identifier for the item to the virtual assistant, the virtual assistant may determine a location for user 102c. The virtual assistant may determine that user 102c is in proximity to merchant location B 1002 where merchant 104b is selling the item that user 102c desires to purchase. Thus, the virtual assistant may determine a purchase request for the item from merchant 104b and cause an order for the item to be communicated to merchant device 160b for fulfillment. Moreover, the virtual assistant may inform user 102c of the location for merchant location B 1002 and/or merchant 104b, as well as merchant information for identification of merchant 104b, so that user 102c may visit merchant location B 1002 and pick up the item for merchant 104b.

However, user 102d is shown as located remotely from all of merchant location A 1000, merchant location B 1002, and merchant location C 1004. Thus, when receiving a message from communication device 110d sent by user 102d, the virtual assistant may require that user 102d identify both the merchant and the item that user 102d is requesting. Where terms are ambiguous in the message, the virtual assistant may ask for clarification from user 102d through communication device 110d. For example, if all of merchants 104a-c sell the item user 102d is requesting, the virtual assistant may provide each merchant's information for selection and ask user 102d to select the merchant. Further, the virtual assistant may store the clarification for later use with the text identifier and/or other information in the message when receiving the same or similar message in the future.

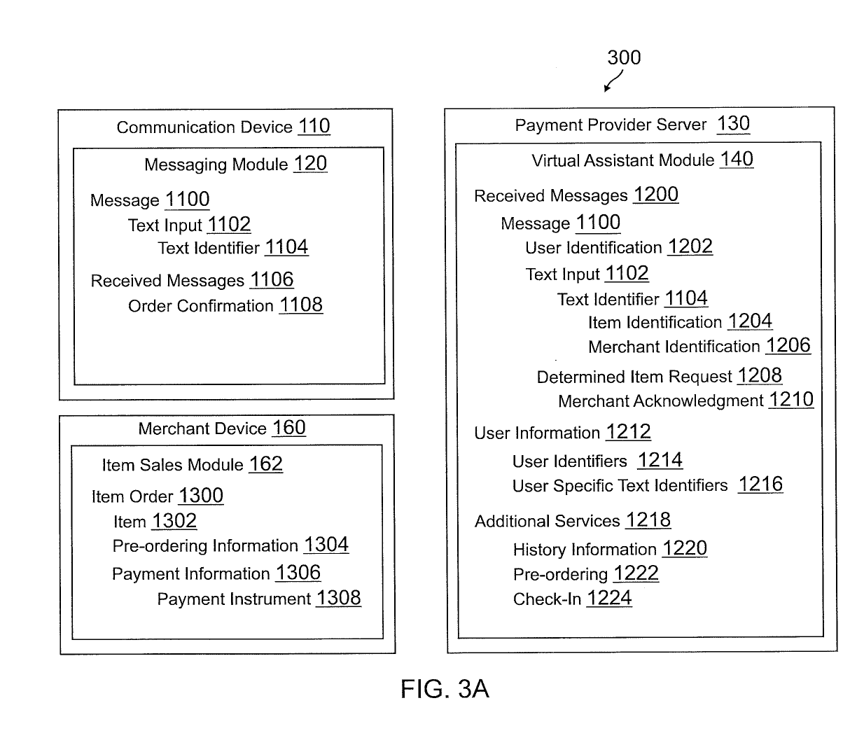

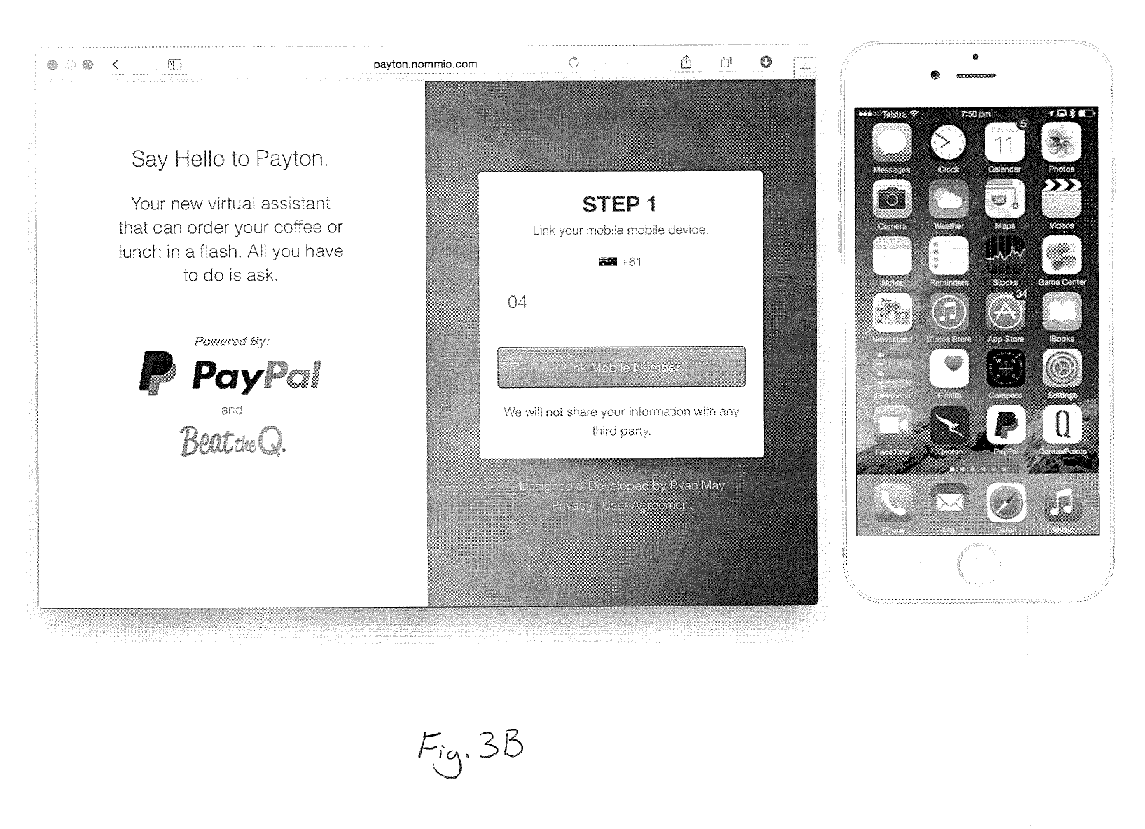

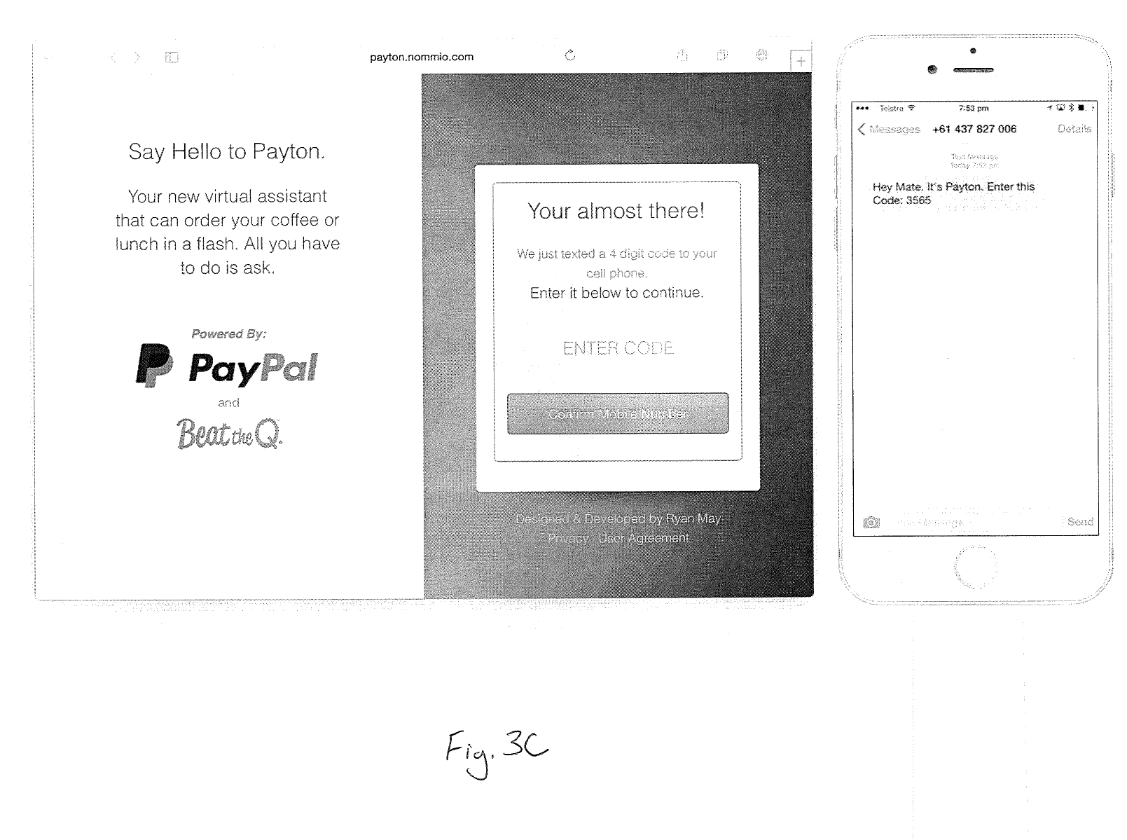

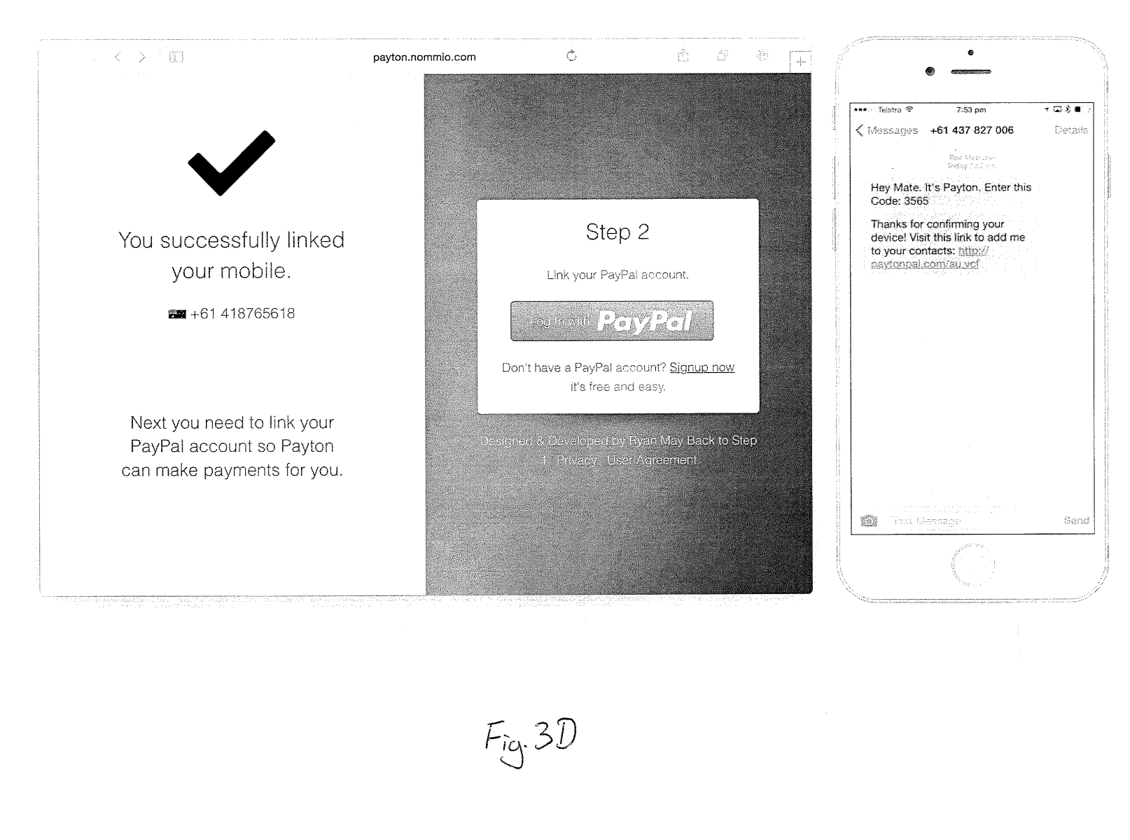

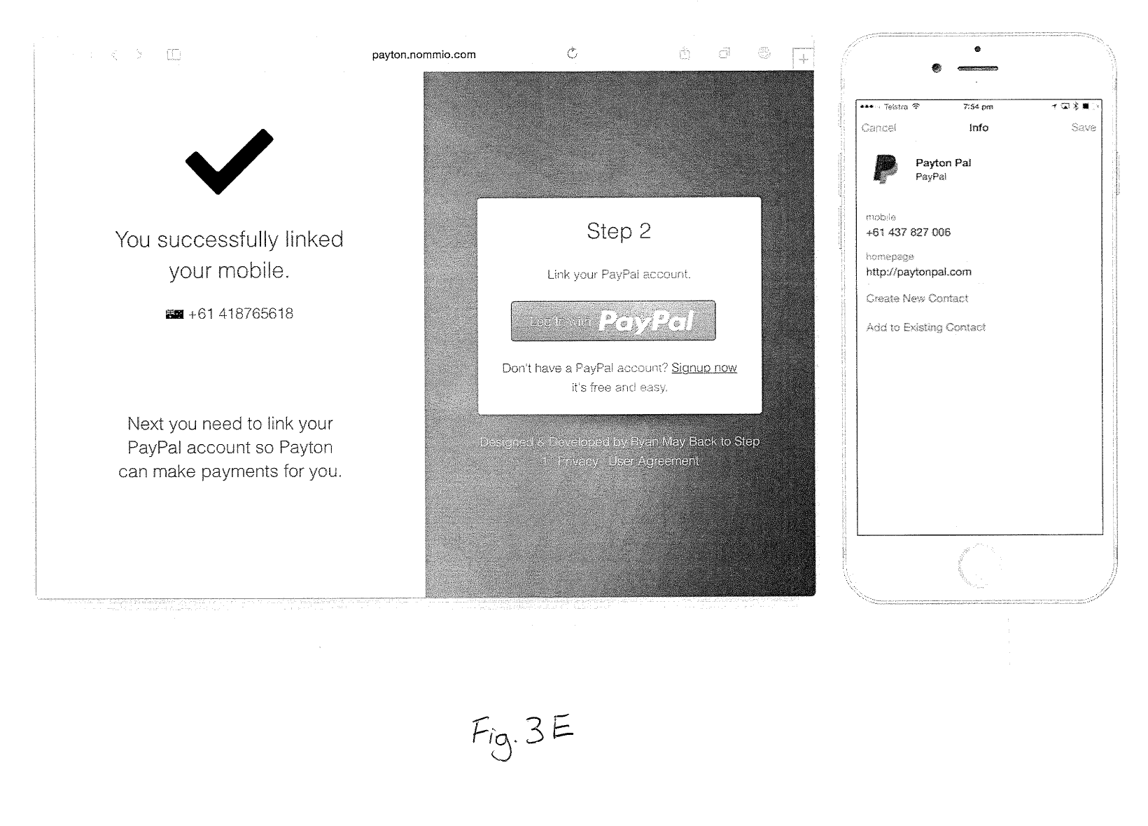

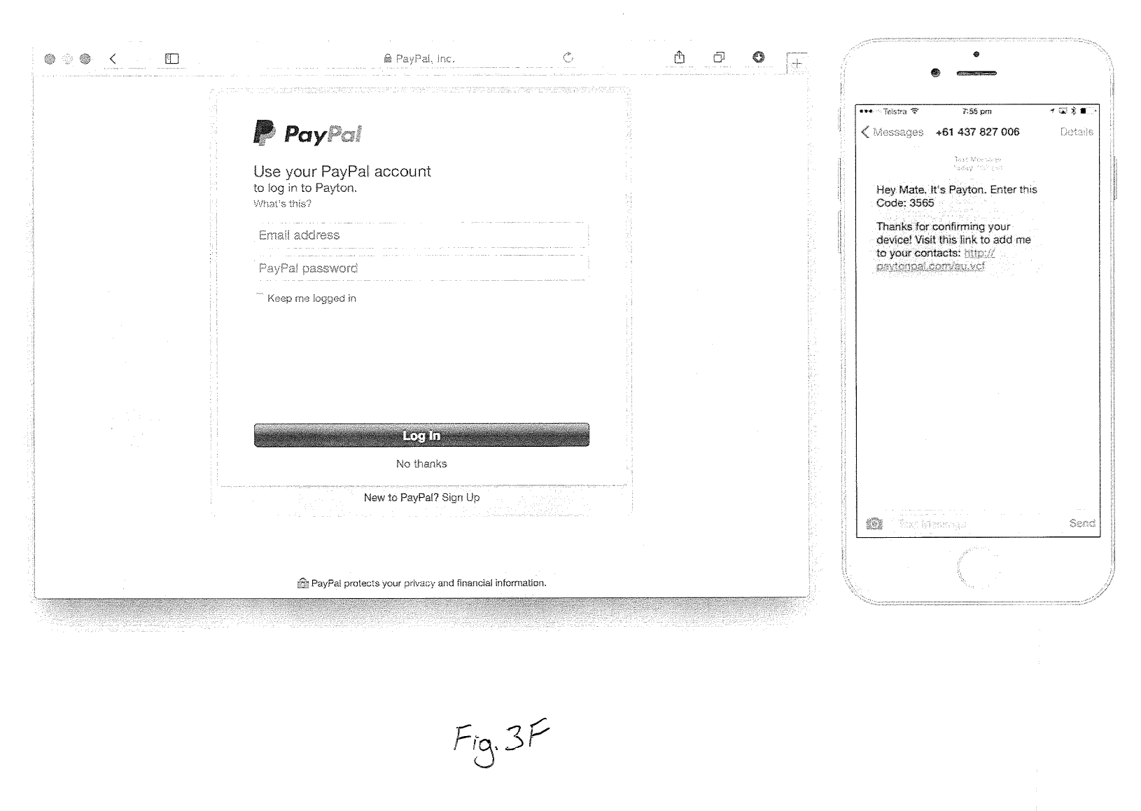

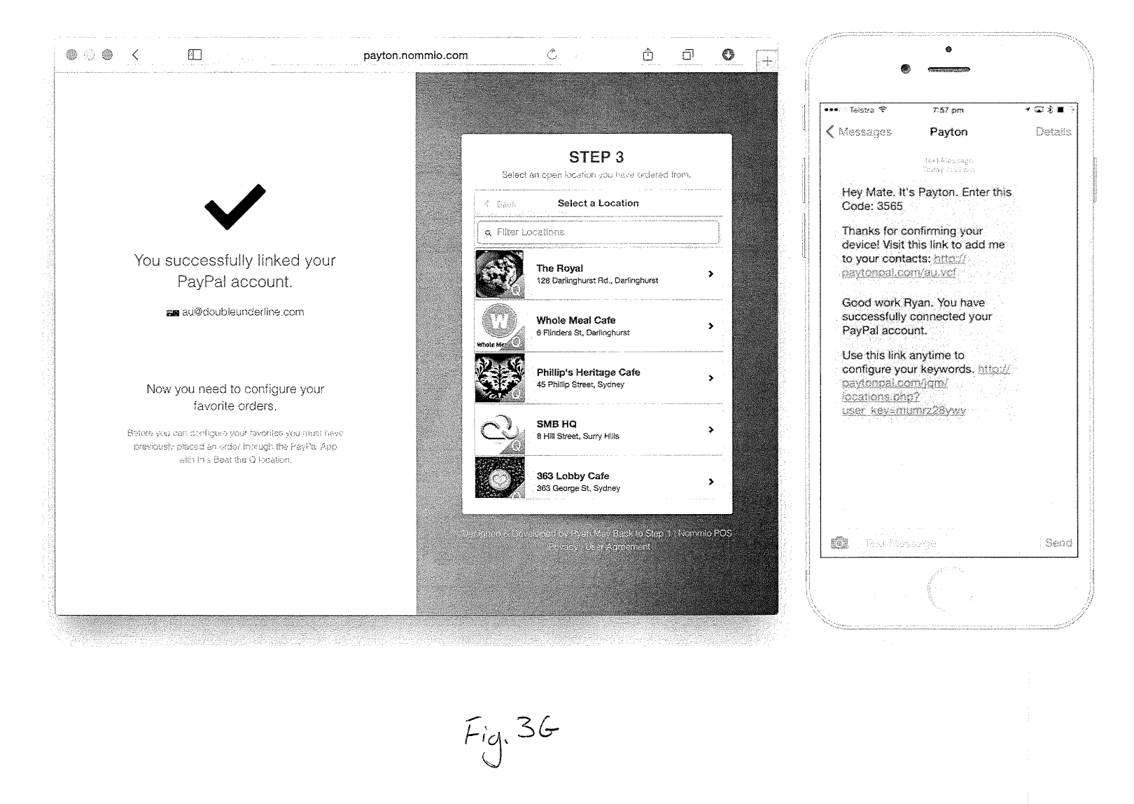

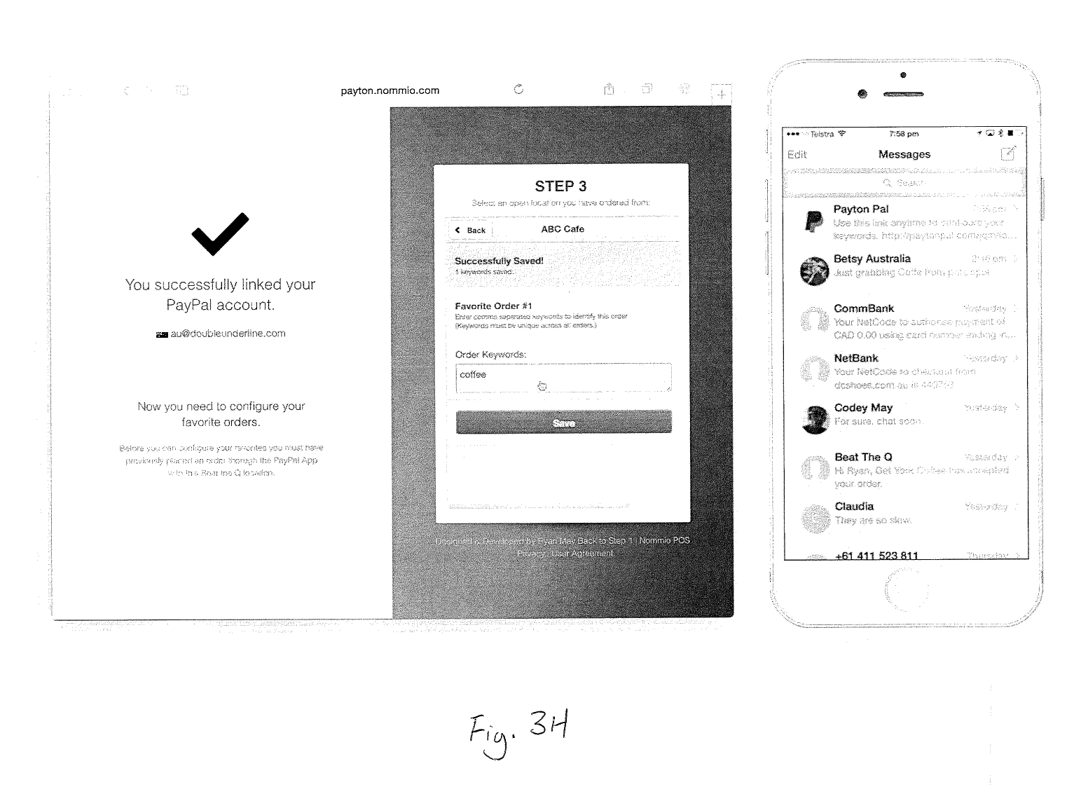

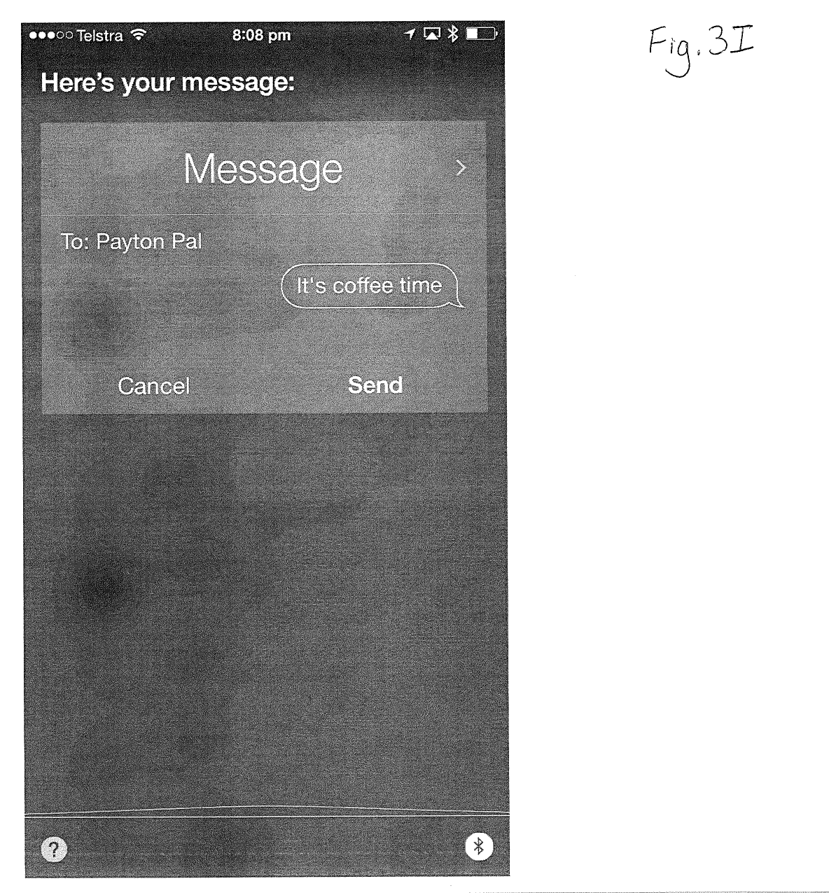

FIG. 3A is an exemplary payment provider server determining item purchase requests for a user based on received messages and other user and device parameters, according to an embodiment. Environment 300 includes communication device 110, payment provider server 130, and merchant device 160 FIG. 1. The below described hardware and/or software modules execute functions as described herein with respect to environment 100.

Communication device 110 executes messaging module 120 having specialized hardware and/or software modules and processes described herein in reference to FIG. 1. In this regard, messaging module 120 may be utilized to communicate messages to payment provider server 130 for an order of an item from a merchant requested by a user (not shown) of communication device 110. Thus, messaging module 120 includes a message 1100, which may have text input 1102, such as a text identifier 1104 that may be utilized to determine what item the user is request and the merchant that the user is requesting the item from. Message 1100 may be communicated to payment provider server 130 over a network connection, which may then be processed by payment provider server 130, as discussed herein. Moreover, payment provider server 130 and/or merchant device 160 may provide reply messages to the user through communication device 110, which may acknowledge receipt of message 1100 and/or fulfillment of the order. Thus, messaging module 120 includes received messages 1106, which may include order confirmation 1108 that informs the user that the order for message 1100 has been entered and/or fulfilled.

Payment provider server 130 executes virtual assistant module 140 having specialized hardware and/or software modules and processes described herein in reference to FIG. 1. In this regard, virtual assistant module 140 includes information used to determine a request for an item from a merchant based on received message 1100 from communication device 110. Virtual assistant module 140 includes received messages 1200, which include message 1100. Using information in and/or received with (or detected to be associated with) message 1100, virtual assistant module 140 may determine user identification 1202, for example, from an identifier for communication device 110 communicating message 1100. Additionally, virtual assistant module may process text input 1102 having text identifier 1104 to determine item identification 1204 and merchant identification 1206. For example, text identifier 1104 may previously be established with payment provider server 130 to correspond to the item and merchant identified in item identification 1204 and merchant identification 1206, respectively. Thus, virtual assistant module 140 may generate a determined item request 1208 using item identification 1204 and merchant identification 1206. Determined item request 1208 may be communicated the merchant device 160, which may provide merchant acknowledgement 1210 of receipt.

In various embodiments, virtual assistant module 140 may require additional information for generation of determined item request 1208. For example, virtual assistant module 140 may utilize user information 1212. User information 1212 may include user identifiers, such as communication device identifiers, user account identifiers, etc. Thus, user identifiers 1214 may be used to determine user identification 1202 as well as the device user 102 is using to send message 1100, which may be used for item identification 1204 and/or merchant identification 1206. Additionally, user information 1212 may include previously established user specific text identifiers 1216. Virtual assistant module 140 may also provide additional services 1218, in various embodiments, which may include history information 1220 (e.g., interesting facts for a location, time, date, person, company, business, food type, event, etc.), pre-ordering 1222, and/or check-in 1224 services.

Merchant device 160 executes item sales module 162 having specialized hardware and/or software modules and processes described herein in reference to FIG. 1. In this regard, item sales module 162 may populate received orders for items by the user corresponding to communication device 110. Thus, item sales module 162 includes an item order 1300, which may correspond to an order generated by an ordering module of payment provider server 130 or a third party ordering service using determined item request 1208. Item order 1300 includes an item 1302 to be prepared or otherwise fulfilled for item order 1300, as well as any pre-ordering information 1304 (e.g., preparation time) and payment information 1306, for example, a payment instrument 1308 for processing. Item order 1300 may also include identification information for the user where necessary by the merchant to provide or delivery item 1302 to the user.

FIGS. 3B-3I are exemplary screenshots of a communication device interface and a payment provider's website interface when setting up a virtual assistant for item orders and submitting a message to the payment provider for the item order, according to an embodiment. Thus, the displayed interfaces in FIGS. 3B-3I are executed by the devices, servers, and/or modules discussed in reference to FIGS. 1, 2, and 3A, for example, communication device 110 and payment provider server 130 of FIGS. 1 and 3A executing associated modules of the device and server, respectively.

For example, FIG. 3B displays interfaces of a payment provider website next to a communication device when a user wishes to set up the payment provider to accept messages and process the messages to determine what the user is requesting. Thus, the user may enter a contact number or other address for the communication device into the interface of the payment provider website when establishing the virtual assistant, named “Payton,” using the virtual assistant module of the payment provider. Once the contact address is entered to the interface, FIG. 3C may show an exemplary establishing message sent to the communication device, which may be used to deter abuse of the system and/or spam as well as confirm that the user's contact address is correct. Thus, the user may enter a code communicated to the user's communication device and displayed through a messaging module to the website interface to confirm the contact address.

Establishment of the virtual assistant may next require linking to a payment account so that payment for requested orders and/or payments may be effectuated in FIG. 3D. However, in other embodiments, the user may instead enter payment instrument(s) used to payment, for example, bank accounts, payment cards, etc. The set up process may continue by adding a contact address for the virtual assistant to a messaging module so that messages may be communicated to the virtual assistant for processing. For example, FIG. 3E may populate interfaces where a contact address for the virtual assistant is stored to the communication device and accessible through a messaging module. Thus, a contact is made with the communication device's messaging module that allows for a message to be communicated to the virtual assistant and processed to determine what purchases and/or payments the user is requesting.

Moreover, the user may be required to log in to the payment account or another account that the user utilizes to perform orders with a merchant. Thus, in FIG. 3F the user may be required to enter in login information for the account. However, where another payment instrument may be utilized, the user may instead log in to an ordering service that stores past orders by the user or may specify the orders themselves. Once the user logs in to the payment account in FIG. 3F (or enters one or more payment instruments), the payment account may be linked to the communication device and past merchants and orders may be populated as well as merchants the user may order items from in the future (e.g., available merchants). The user may then select a merchant and/or item to set up an order when a text identifier (or other information) is received. For example, the text identifier coffee is entered in FIG. 3H, which is associated with an order at ABC café called favorite order #1. Thus, in FIG. 3I, when “coffee” is transmitted in the message to the virtual assistant, favorite order #1 may be ordered.

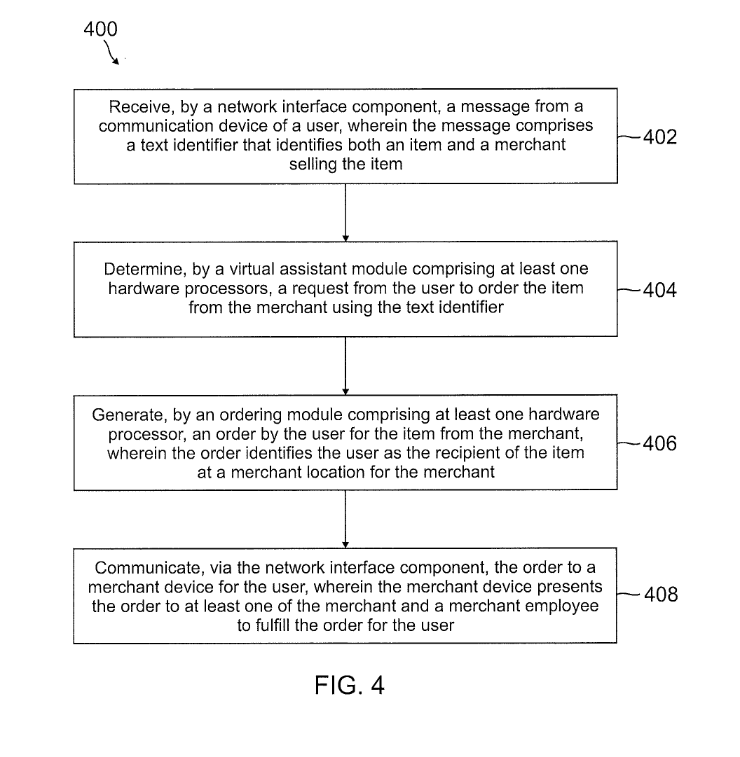

FIG. 4 is a flowchart of an exemplary process for a virtual assistant server providing services requested through device communications, according to an embodiment. Note that one or more steps, processes, and methods described herein may be omitted, performed in a different sequence, or combined as desired or appropriate.

At step 402, a message is received from a communication device of a user via a network interface component, wherein the message comprises a text identifier that identifies both an item and a merchant selling the item. The user may enter the message to a messaging module of the communication device using one of a microphone with a voice input to text input process, a touch sensitive interface, or a keypad. Thus, the message may comprise one of a SMS message, MMS message, voice message, or instant messaging message. Thus, at step 404, a request from the user to order the item from the merchant is determined, by a virtual assistant module comprising at least one hardware processor, using the text identifier. In various embodiments, the determining the request may further use at least one parameter for the message comprising one of location of the communication device, a device type for the communication device, an identification of the communication device, a timestamp of the message, and a biometric measurement of the user. The at least one parameter for the message may be set by the user for at least one of the order, the item, and the merchant. For example, at least one of the item and the merchant may be further identified using user information for the user comprising at least one of a location of the user, a timestamp of first message, an identifier for the communication device and a device type of the communication device.

An order by the user for the item from the merchant is generated, by an ordering module comprising at least one hardware processor, wherein the order identifies the user as the recipient of the item at a merchant location for the merchant, at step 406. At step 408, the order is communicated, via the network interface component, to a merchant device for the user, wherein the merchant device presents the order to at least one of the merchant and a merchant employee to fulfill the order for the user. In certain embodiments, the message may further comprise a preorder time comprising one of a delay in sending the order to the merchant by the ordering module and a pickup time for the item from the merchant location. For example, the virtual assistant module may wait to cause the ordering module to generate the order for the preorder time. Additionally, if the text identifier includes an extra input or an unknown input, a clarification of the extra input or the unknown input may be requested and the clarification may be stored for future use with the text identifier on receipt of the extra input or the unknown input in at least one future message.

A change to the user information may cause identification of the item from another merchant at a different merchant location or identification of the other item from one of the first merchant and the other merchant. In such embodiments, the virtual assistant module may determine a different request using the change, and cause the ordering module to generate a second order using the different request. The virtual assistant module may further determine a stored request for reordering the first item from the first merchant using the ordering module to generate a second order for the first item from the first merchant, wherein a database stores the stored request for future use in ordering the first item from the first merchant without receiving a second message comprising the first text identifier. The virtual assistant module may also further determine a time for the ordering module to generate the second order to the first merchant for ordering of the first item from the first merchant, and may cause the ordering module to generate the second order at this time, for example, by communicating the stored request to the ordering module at the time, by causing the ordering module to access the stored request at the time, or by releasing the stored request to the ordering module at the time. In various embodiments, the virtual assistant module may further determine that the user is varying from a pattern associated with ordering the item from the merchant and delays the ordering module from communicating the second order to the first merchant for confirmation or cancellation of stored order by the user. The virtual assistant module may determine that the user is varying from the pattern using at least one of a location of the user, biometrics for the user, and a message communicated by the user using the communication device.

The virtual assistant module may receive a check in request from the communication device at a location of the user and process a check-in for the user at the location to associate the user with the location. Moreover, a transaction processing module may process a transaction for the item using the order, wherein the transaction processing module provides a payment for the item to the merchant. The transaction processing module may process the transaction after acceptance by merchant to fulfill the order. The message may identify a payment instrument for use in providing the payment for the item to the merchant. Additionally, a database may further store a second text identifier for one of a second item from the merchant or another second merchant and the original first item from the second merchant. Thus, where the network interface component receives another message comprising the second text identifier, the virtual assistant module may determines a second request using the second text identifier, and the ordering module may further generate a second order using the second request.

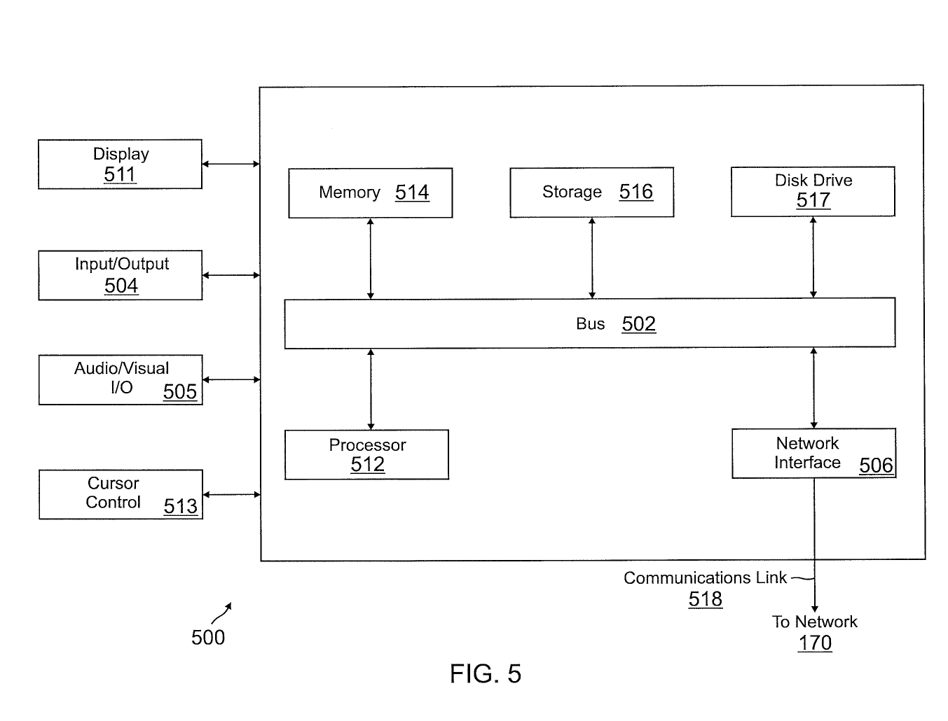

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, a merchant server, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a virtual assistant module comprising at least one hardware processor that accesses a first message communicated by a communication device of a user, wherein the first message comprises a first text identifier that identifies both a first item and a first merchant selling the first item and determines a first request from the user to order the first item from the first merchant using the first text identifier;
an ordering module comprising at least one hardware processor that accesses the first request and generates a first order by the user for the first item from the first merchant, wherein the first order identifies the user as the recipient of the first item at a first merchant location for the first merchant;
a database stored to a non-transitory memory that the first message, the first request, and the first order; and
a network interface component that receives the first message from the communication device of the user and communicates the first order to a merchant device for the user, wherein the merchant device presents the first order to at least one of the first merchant and a merchant employee at the first merchant location to fulfill the first order for the user.

2. The system of claim 1, wherein, prior to the communication device communication the first message to the network interface component, the user enters the first message to a messaging module of the communication device using one of a microphone with a voice input to text input process, a touch sensitive interface, or a keypad.

3. The system of claim 2, wherein the first message comprises one of a SMS message, MMS message, voice message, or instant messaging message.

4. The system of claim 1, further comprising:
a transaction processing module that processes a transaction for the first item using the first order and provides a payment for the first item to the first merchant.

5. The system of claim 4, wherein the transaction processing module processes the transaction after acceptance by first merchant to fulfill the first order.

6. The system of claim 4, wherein the first message identifies a payment instrument for use in providing the payment for the first item to the first merchant.

7. The system of claim 1, wherein at least one of the first item and the first merchant is further identified using user information for the user comprising at least one of a location of the user, a timestamp of first message, an identifier for the communication device and a device type of the communication device.

8. The system of claim 7, wherein a change to the user information causes identification of the first item from a second merchant at a second merchant location or identification of a second item from one of the first merchant and the second merchant, wherein the virtual assistance module determines a second request using the change, and wherein the ordering module generates a second order using the second request.

9. The system of claim 1, wherein the database further stores a second text identifier for one of a second item from the first merchant or a second merchant and the first item from the second merchant, wherein the network interface component receives a second message comprising the second text identifier, wherein the virtual assistant module determines a second request using the second text identifier, and wherein the ordering module further generates a second order using the second request.

10. The system of claim 1, wherein the first message further comprises a preorder time comprising one of a delay in sending the first order to the first merchant and a pickup time for the first item from the first merchant location.

11. The system of claim 1, wherein the virtual assistant module further determines a stored request for reordering the first item from the first merchant using the ordering module to generate a second order for the first item from the first merchant, and wherein the database stores the stored request for future use in ordering the first item from the first merchant without receiving a second message comprising the first text identifier.

12. The system of claim 11, wherein the virtual assistant module further determines a time for the ordering module to generate the second order to the first merchant for ordering of the first item from the first merchant.

13. The system of claim 11, wherein the virtual assistant module further determines that the user is varying from a pattern associated with ordering the first item from the first merchant and delays the ordering module from communicating the second order to the first merchant for confirmation or cancellation of stored order by the user.

14. The system of claim 13, wherein the virtual assistant module determines that the user is varying from the pattern using at least one of a location of the user, biometrics for the user, and a message communicated by the user using the communication device

15. A method comprising:
receiving, via a network interface component, a message from a communication device of a user, wherein the message comprises a text identifier that identifies both an item and a merchant selling the item;
determining, by a virtual assistant module comprising at least one hardware processors, a request from the user to order the item from the merchant using the text identifier;
generating, by an ordering module comprising at least one hardware processor, an order by the user for the item from the merchant, wherein the order identifies the user as the recipient of the item at a merchant location for the merchant; and
communicating, via the network interface component, the order to a merchant device for the user, wherein the merchant device presents the order to at least one of the merchant and a merchant employee to fulfill the order for the user.

16. The method of claim 15, wherein the determining the request further uses at least one parameter for the message comprising one of location of the communication device, a device type for the communication device, an identification of the communication device, a timestamp of the message, and a biometric measurement of the user.

17. The method of claim 16, wherein the at least one parameter for the message is set by user for at least one of the order, the item, and the merchant.

18. The method of claim 15, wherein the text identifier includes an extra input or an unknown input, and wherein the method further comprises:
requesting a clarification of the extra input or the unknown input; and
storing the clarification for future use with the text identifier on receipt of the extra input or the unknown input in at least one future message.

19. The method of claim 15, further comprising:
receiving, by the virtual assistant module, a check in request from the communication device at a location of the user; and
processing, by the virtual assistant module, a check-in for the user at the location to associate the user with the location.

20. A non-transitory computer-readable medium comprising executable modules which, in response to execution by a computer system, cause the computer system to perform a method comprising:
receiving, via a network interface component, a message from a communication device of a user, wherein the message comprises a text identifier that identifies both an item and a merchant selling the item;
determining, by a virtual assistant module comprising at least one hardware processor, a request from the user to order the item from the merchant using the text identifier;
generating, by an ordering module comprising at least one hardware processor, an order by the user for the item from the merchant, wherein the order identifies the user as the recipient of the item at a merchant location for the merchant; and
communicating, via the network interface component, the order to a merchant device for the user, wherein the merchant device presents the order to at least one of the merchant and a merchant employee to fulfill the order for the user.
